(19) United States
(12) Patent Application Publication
(10) Pub. No.: US 2026/0255141 A1
(43) Pub. Date: Aug. 27, 2026

(54) EMERGENCY CALL HANDLING DURING ENERGY SAVING IN CELLULAR NETWORK

(71) Applicant: DISH Wireless L.L.C., Englewood, CO (US)

(72) Inventor: Rahul Anand, Parker, CO (US)

(21) Appl. No.: 19/063,647

(22) Filed: Feb. 26, 2025

(51) Int. Cl. H04W 4/90; H04W 52/02

(52) U.S. Cl. CPC H04W 4/90; H04W 52/0216

(57) ABSTRACT

Technologies for emergency call handling in energy saving scenario in a cellular network are described. One method include determining whether an energy saving function is activated in a base station of the cellular network, wherein the base station comprises a first cell and a second cell; responsive to determining that the energy saving function is activated in the base station, determining whether the first cell is scheduled to be turned off at a first time point; responsive to determining that the first cell is scheduled to be turned off at the first time point, determining, at the first time point, whether one or more ongoing calls using the first cell comprise an emergency call; and responsive to determining that the one or more ongoing calls using the first cell comprise the emergency call, postpone turning off the first cell.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some energy saving scenario in a 5G NR cellular network can be improved to facilitate such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing emergency call handling in energy saving scenario in a cellular network according to at least one embodiment.

FIG. 2 is a block diagram of a system including an emergency call handling component that implements emergency call handling in energy saving scenario in a cellular network according to at least one embodiment.

FIG. 3 is a block diagram of example implementations of emergency call handling in energy saving scenario in a cellular network according to at least one embodiment.

FIGS. 4 and 5 are flow diagrams of example methods of implementing emergency call handling in energy saving scenario in a cellular network according to at least one embodiment.

FIG. 6 is a block diagram of an example computer system in which embodiments of the present disclosure can operate.

### DETAILED DESCRIPTION

Technologies for implementing emergency call handling in energy saving scenario in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

In the energy saving scenario, power consumption of the radio units (RUs) in the cellular network is reduced by switching off the unnecessary cells, for example, in case of low traffic load. The energy saving scenario is better to be operated in an environment where multi-carriers are overlapped in a co-located cell site. For example, when the traffic load is low, one or more cells can be turned off at a preset time point, and as such, the existing connected calls may be forced to be handover to another cell for the coverage area. If the handover fails, the connected calls will be dropped off. There is no separate handling for emergency (EMG) calls, which should not be dropped off.

Aspects and embodiments of the present disclosure address the above and other deficiencies by providing a system that implements emergency call handling in energy saving scenario in a cellular network. Specifically, a component of the cellular network (e.g., emergency call handling component) may be implemented into each of the base stations in the cellular network. The base station (e.g., “gNodeB” or “gNB”) refers to a network element responsible for the transmission and reception of radio signals in one or more cells (or coverage areas) to or from user equipment (UE).

In some implementations, the emergency call handling component of the base station may determine whether an energy saving function is activated in the base station of the cellular network, wherein the base station comprises multiple cells. For example, the emergency call handling component may determine whether an energy saving function in the base station is activated by determining whether a parameter of the base station has a specific value, where the parameter (“activation parameter”) indicates that one or more cells in the base station can be turned off.

In some implementations, responsive to determining that the energy saving function in the base station is activated, the emergency call handling component may determine whether a cell in the base station is scheduled to be turned off at a time point (e.g., T1). For example, the emergency call handling component may determine whether a cell in the base station is scheduled to be turned off at a time point by determining whether a parameter of the cell has a specific value, where the parameter (“time parameter”) indicates that the cell is turned off at the time point of the specific value.

In some implementations, responsive to determining that the cell in the base station is scheduled be turned off at the first time point, the emergency call handling component may determine, at the first time point, whether one or more ongoing calls using the cell comprise an emergency call. For example, to determine whether one or more ongoing calls using the cell comprise an emergency call, the emergency call handling component may check one or more parameters of data transmissions in the cell, where the parameter(s) (“emergency call parameter(s)”) indicate whether the data transmission is in a voice type and whether the data transmission that is in the voice type is an emergency call.

In some implementations, responsive to determining that one or more ongoing calls in the cell comprise an emergency call, the emergency call handling component may postpone turning off the cell such that the emergency call can be finished before turning off the cell.

In some implementations, the emergency call handling component may determine whether the emergency call is finished. In some implementations, to determine whether the emergency call is finished, the emergency call handling component may check a parameter of data transmission associated with the emergency call, where the parameter (“completion parameter”) indicates the data transmission associated with the emergency call is completed (e.g., a specific code or sequence at the end of the data transmission stream to represent the completion of data transmission). For example, when the completion parameter of data transmission associated with the emergency call has a value that indicates the completion of the data transmission, the emergency call handling component may determine that the emergency call is finished. In some implementations, responsive to determining that the emergency call is finished, the emergency call handling component may turn off the cell. In some implementations, responsive to determining that the emergency call is not finished, the emergency call handling component may continue postponing turning off the cell.

Aspects and embodiments of the present disclosure can provide a separate mechanism to handle the emergency call in the energy saving scenario. Instead of dropping off the emergency call, aspects of the present disclosure can allow the emergency call to be finished before a cell is turned off for the energy saving purpose.

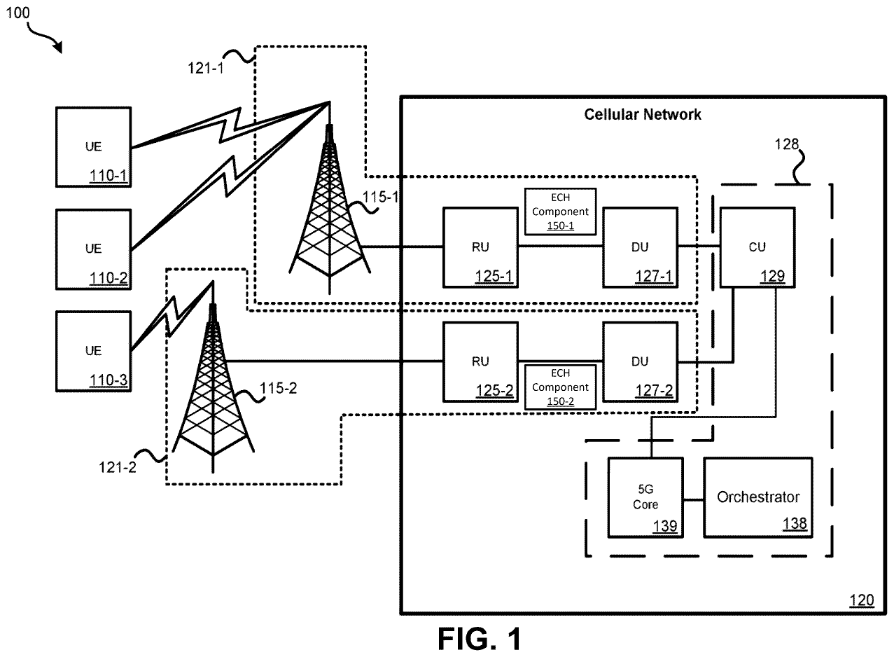

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed. 5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF). User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

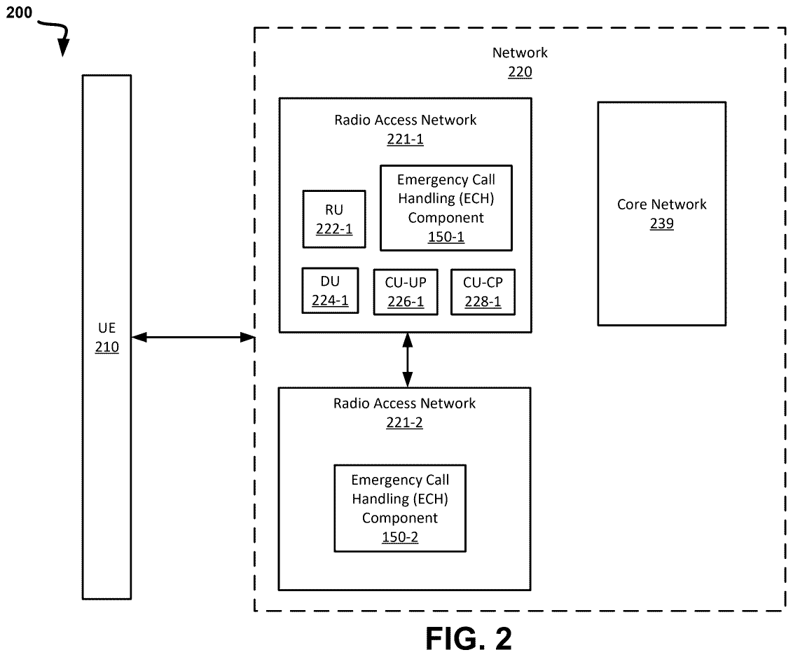

In some embodiments, each base station can include an emergency call handling (ECH) component 150 to implement emergency call handling in energy saving scenario in a cellular network. For example, the base station 121-1 includes an emergency call handling component 150-1 and the base station 121-2 includes an emergency call handling component 150-2. Further details regarding the operations of the emergency call handling component are described below with reference to FIGS. 2-6.

FIG. 2 is a block diagram of example emergency call handling components according to at least one embodiment. Referring to FIG. 2, a network 220 includes one or more radio access network (RAN) 221-1, 221-2, and one or more core network 239 according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221-1, 221-2 via a wireless connection. The UE 210 can include one of a number of UEs not depicted that are in communication with the RAN 221-1, 221-2. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221-1, 221-2.

The RAN 221-1 includes a radio unit (RU) 222-1 for wirelessly communicating with UE 210. The radio unit (RU) 222-1 may include one or more radio transceivers for wirelessly communicating with UE 210. The radio unit (RU) 222-1 may include circuitry for converting signals sent to and from an antenna of a Base Station into digital signals for transmission over packet networks. In some implementations, the RAN 221-1 may correspond with a 5G radio base station that connects user equipment to the core network 239. The 5G radio base station may be referred to as a generation Node B, a “gNodeB,” or a “gNB.” In some implementations, the RAN 221-1 may correspond with other generation base station, such as a fourth generation (4G) or long term evolution (LTE) radio base station (referred to as an evolved Node B, a “eNodeB,” or a “eNB”), or sixth generation (6G) that connects user equipment to the core network 239. A base station may refer to a network element that is responsible for the transmission and reception of radio signals in one or more cells to or from user equipment, such as UE 210.

The RAN 221-1 can include a new-generation radio access network (NG-RAN) that uses the 5G NR interface. In some embodiments, the distributed unit (DU) 224-1 and the centralized unit (CU) of the RAN 221-1 may be co-located with the RU 222-1. In other embodiments, the DU 224-1 and the RU 222-1 may be co-located at a cell site and the centralized unit (CU) may be located within a local data center (LDC). The DU 224-1 can include a logical node configured to provide functions for the radio link control (RLC) layer, the medium access control (MAC) layer, and the physical layer (PHY) layers. The centralized unit (CU) can be partitioned into a CU user plane portion (CU-UP) 226-1 and a CU control plane portion (CU-CP) 228-1. The CU-CP 228-1 may perform functions related to a control plane, such as connection setup, mobility, and security. The CU-UP 226-1 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228-1 can include a logical node configured to provide functions of the control plane part of the RRC and PDCP. The centralized unit for the user plane(CU-UP) 226-1 can include a logical node configured to provide functions of the user plane part of the SDAP and PDCP. In some embodiments, the RAN 221-1 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221-1 may include a set of one or more radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF), the session management function (SMF), and the user plane function (UPF). The AMF may interface with UE 210, act as a single-entry point for a UE connection, and perform mobility management, registration management, and connection management between data network and UE 210. The AMF may interface with the SMF to track user sessions. The AMF may interface with a network slice selection function (NSSF) 338 to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and Internet Protocol (IP) address allocation. After the Access Gateway Function (AGF) authenticates the subscriber and establishes a protocol data unit (PDU) session, the SMF may select the UPF for the subscriber. The UPF may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the data network to the UE 210, via the RAN 221-1 and/or transfer uplink data received from the UE 210 to the data network via the RAN 221-1. An uplink can include a radio link though which UE 210 transmits data and/or control signals to the RAN 221-1. A downlink can include a radio link through which the RAN 221-1 transmits data and/or control signals to the UE 210.

Uplink packets arriving from the RAN 221-1 may use a general packet radio service (GPRS) tunneling protocol (or GTP) to reach the UPF. The GPRS tunneling protocol for the user plane may support multiplexing of traffic from different PDU sessions by tunneling user data over the interface N3 between the RAN 221-1 and the UPF. The UPF may remove the packet headers belonging to the GTP tunnel before forwarding the user plane packets towards the data network. As the UPF may provide connectivity towards other data networks in addition to the data network, the UPF ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221-1. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF that supports the network slice instance may be selected and a PDU session via the network slice instance may be established. In some cases, the PDU session may be of type IPv4 or IPv6 for transporting IP packets. The RAN 221-1 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

Using FIG. 2 as an illustrative example, RAN 221-1 may include emergency call handling component 150-1. The emergency call handling component 150-1 may determine whether RAN 221-1 has an energy saving function activated. The energy saving function refers to a situation where one or more cells can be switched on or off depending on the actual data traffic load in a particular coverage area at a particular time, while at least one cell is kept on and responsible for providing coverage in the area at any time. For example, multiple cells are needed during the daytime in the city center for heavy data traffic load, but during the nighttime, some of them can be put into sleep mode as data traffic is reduced.

RAN 221-1 may represent a base station (such as “gNB”) that is a network element responsible for the transmission and reception of radio signals in one or more cells (or coverage areas) to or from UE 210. RAN 221-1 may provide multiple band layers, including one or more low-band layers, one or more mid-band layers, and/or one or more high-band layers. The low-band layer (e.g., below 7 GHz in frequency division duplex (FDD)) may provide a wide coverage area and limited bandwidth capacity. The mid-band layer (e.g., below 7 GHz, in time division duplex (TDD)) may provide a smaller coverage area, a higher bandwidth capacity compared to the low-band layer. The high-band layer (i.e., millimeter wave (e.g., above 24 GHz)) may provide poorer uplink coverage compared to both the mid- and low-bands but unprecedented peak rates and low latency.

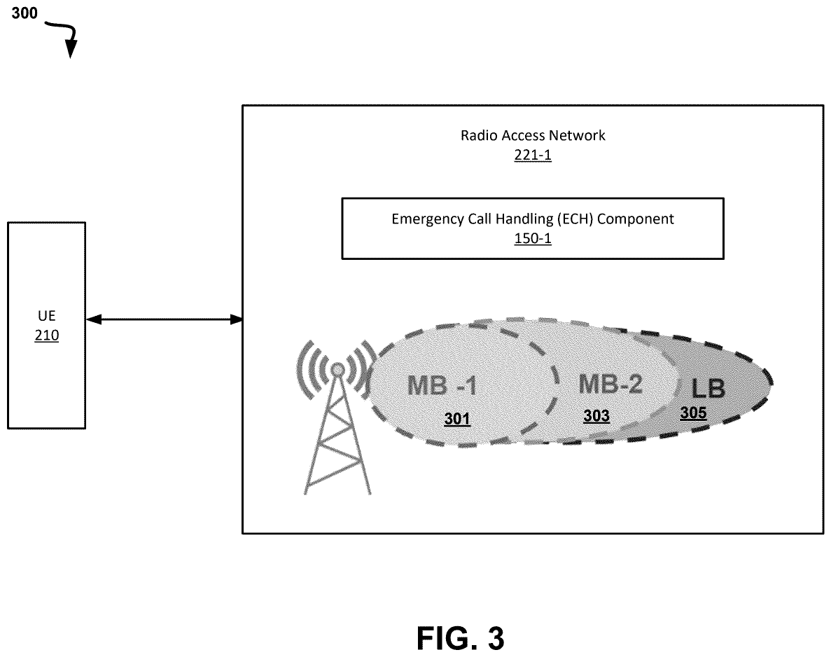

In some implementations, a first cell may provide one or more low-band layer. In some implementations, a second cell may provide one or more mid-band layer. In some implementations, a third cell may provide one or more high-band layer. In some implementations, a fourth cell may provide one or more low-band layer, mid-band layer, or high-band layer. FIG. 3 illustrates example implementations of emergency call handling in energy saving scenario. As shown in the example of FIG. 3, the cell 301 may provide a first mid-band layer MB-1, the cell 303 may provide a second mid-band layer MB-2, and the cell 305 may provide a low-band layer LB.

In some implementations, the emergency call handling component 150-1 may determine whether an energy saving function in the RAN 221-1 is activated by determining whether a parameter of RAN 221-1 has a specific value, where the parameter (“activation parameter”) indicates that one or more cells in RAN 221-1 can be turned off. In one example, when the activation parameter has a bit value “1,” one or more cells in RAN 221-1 can be turned off based on the data traffic load for energy saving purpose, and the emergency call handling component 150-1 may determine that the energy saving function in the RAN 221-1 is activated; when the activation parameter has a bit value “0,” cells in RAN 221-1 cannot be turned off for energy saving purpose, and the emergency call handling component 150-1 may determine that the energy saving function in the RAN 221-1 is not activated.

In some implementations, responsive to determining that the energy saving function in the RAN 221-1 is activated, the emergency call handling component 150-1 may determine whether a cell in the RAN 221-1 is scheduled to be turned off at a time point (e.g., T1). In some implementations, the emergency call handling component 150-1 may determine whether a cell in the RAN 221-1 is scheduled to be turned off at a time point by determining whether a parameter of the cell has a specific value, where the parameter (“time parameter”) indicates that the cell is turned off at the time point of the specific value. The specific value can be determined and changed by the RAN 221-1 or the cell. For example, the RAN 221-1 may determine the data traffic load in the RAN 221-1 at the time point TX and determine that the cell is not necessary to handle the data traffic load, and then determine to turn off the cell at a preset interval (T1) tine point after TX, and as such, the RAN 221-1 can set the time parameter of the cell as T1. In one example, when the time parameter has a value “T1,” the emergency call handling component 150-1 may determine that the cell is scheduled to be turned off at the time point T1. Using FIG. 3 as an illustrative example, the emergency call handling component 150-1 may determine that the cell 301 is scheduled to be turned off at the time point T1.

In some implementations, responsive to determining that the cell in the RAN 221-1 is scheduled be turned off at the first time point, the emergency call handling component 150-1 may determine, at the first time point, whether one or more ongoing calls using the cell comprise an emergency call. In some implementations, to determine whether one or more ongoing calls using the cell comprise an emergency call, the emergency call handling component 150-1 may determine whether one or more calls are ongoing using the cell, and responsive to determining that one or more calls are ongoing using the cell, determine whether any of the ongoing calls is an emergency call. In some implementations, to determine whether one or more ongoing calls using the cell comprise an emergency call, the emergency call handling component 150-1 may check one or more parameters of data transmissions in the cell, where the parameter(s) (“emergency call parameter(s)”) indicate whether the data transmission is in a voice type and whether the data transmission that is in the voice type is an emergency call. Using FIG. 3 as an illustrative example, the emergency call handling component 150-1 may determine that one or more ongoing calls using the cell 301 comprise an emergency call.

In some implementations, responsive to determining that one or more ongoing calls in the cell comprise an emergency call, the emergency call handling component 150-1 may postpone turning off the cell such that the emergency call can be finished before turning off the cell. Using FIG. 3 as an illustrative example, the emergency call handling component 150-1 may postpone turning off the cell 301. In some implementations, to postpone turning off the cell, the emergency call handling component 150-1 may change a value of the time parameter of the cell, wherein the time parameter specifies the time point to turn off the cell. For example, the emergency call handling component 150-1 may change the value from 0 to T2, where T2 is a preset value.

In some implementations, the emergency call handling component 150-1 may determine whether the emergency call is finished. In some implementations, to determine whether the emergency call is finished, the emergency call handling component 150-1 may check a parameter of data transmission associated with the emergency call, where the parameter (“completion parameter”) indicates the data transmission associated with the emergency call is completed (e.g., a specific code or sequence at the end of the data transmission stream to represent the completion of data transmission). For example, when the completion parameter of data transmission associated with the emergency call has a value that indicates the completion of the data transmission, the emergency call handling component 150-1 may determine that the emergency call is finished. In some implementations, responsive to determining that the emergency call is finished, the emergency call handling component 150-1 may turn off the cell. Using FIG. 3 as an illustrative example, responsive to determining that the emergency call is finished, the emergency call handling component 150-1 may turn off the cell 301.

In some implementations, the emergency call handling component 150-1 may determine, at the postponed time point (e.g., T2) whether the emergency call is finished, and responsive to determining that the emergency call is not finished, continue postponing turning off the cell (e.g., by changing the value of the time parameter of the cell, wherein the time parameter specifies the time point to turn off the cell as described above).

In some implementations, responsive to determining that one or more ongoing calls do not comprise an emergency call, the emergency call handling component 150-1 may handover the data transmission from the current cell to another cell and turn off the current cell after handover is completed (regardless of successfully). The handover allows UE 210 to stay connected to the network. As UE makes regular measurements of neighboring cells, UE 210 reports the measurements to the network such that the network 220 can initiate and complete the handover. The handover can be made from a source cell and a target cell. The source cell is the cell that UE is connected to before handover, and the target cell is the cell that UE is connected to after handover. The source cell may initialize a handover based on the measurements provided by UE 210. The source cell may obtain the IP address of a target cell. Using FIG. 3 as an illustrative example, the cell 301 may be a source cell and the cell 303 may be a target cell, or the cell 301 may be a source cell and the cell 305 may be a target cell, etc.

The source cell may send a handover request to the target cell. In addition to the handover request, the source cell may start the process of exchanging information regarding parameters associated with handover with the target cell. For example, the source cell may send source handover parameters to the target cell, and the target cell, upon receiving the source handover parameters, may compare the received handover parameters with its corresponding target handover parameters. The target cell may flag the unmatched handover parameters between the source handover parameters and the target handover parameters. The target cell may attempt to reconfigure the unmatched handover parameters such that the target handover parameters all match the source handover parameters. In some cases, the target cell may be able to successfully reconfigure the unmatched handover parameters, and in such cases, the target cell may determine that a matched set of the handover parameters has existed and then send to the source cell an acknowledgement that the handover parameters matching is finished. Then, the target cell may perform the admission control based on slice information to admit UE as a normal procedure after receiving the handover request from the source cell, which means that the handover is completed and successful.

In some cases, if exchange of information with attempted handover parameters matching have been performed in a specific number of rounds, between the source cell and the target cell, that exceeds a threshold value (e.g., over X rounds), the source cell and/or the target cell may send an error notification for the handover, which means that the handover is completed, although unsuccessfully. The unsuccess handover may be caused by various issues associated with the handover strategy, including the weather, the signal fading in the network, etc. Upon the completion of the handover regardless of success, the emergency call handling component 150-1 may turn off the cell.

In some implementations, RAN 221-2 may be same as the RAN 221-1 described above, and the RAN 221-2 may include the emergency call handling component 150-2, which may perform the functions similar to that of the emergency call handling component 150-1.

In some implementations, a system (e.g., system 100 in FIG. 1, or system 200 in FIG. 2) may include a computing system to facilitate a cellular network (e.g., the cellular network 120 in FIG. 1, or network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to an emergency call handling component (e.g., the emergency call handling component of FIGS. 1-3).

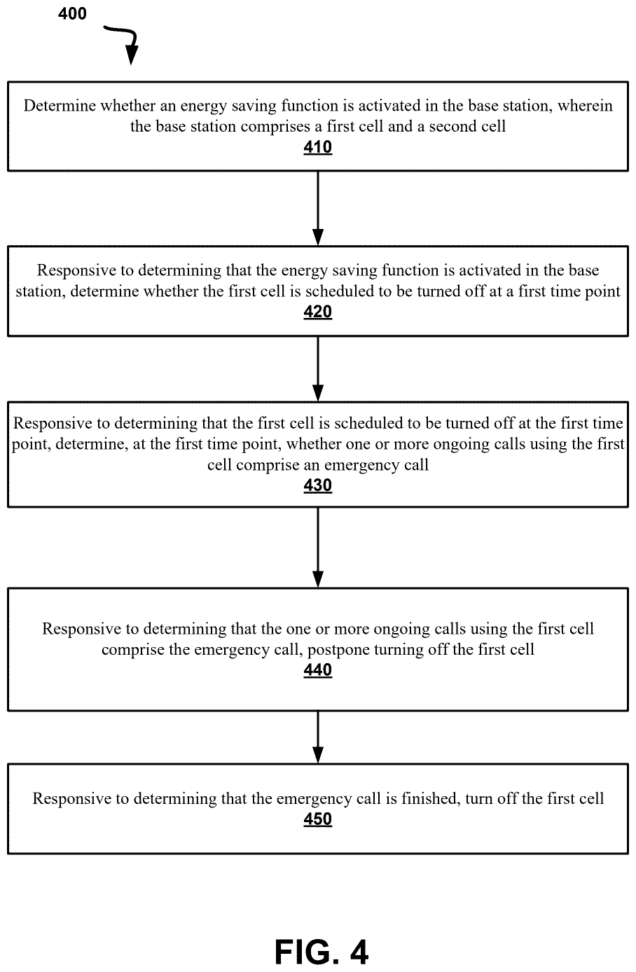

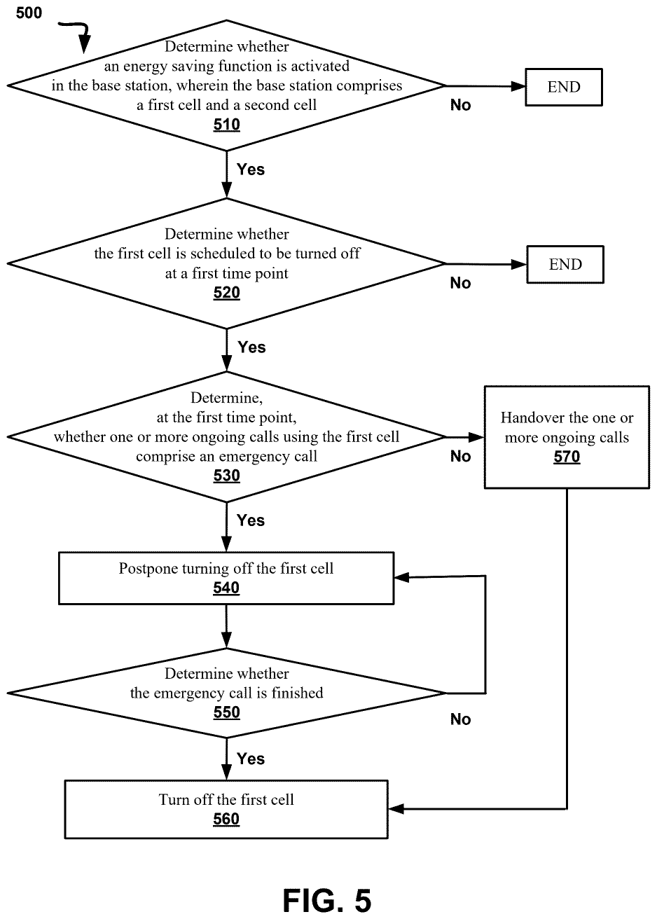

FIGS. 4 and 5 are flow diagrams of methods 400 and 500 of implementing emergency call handling in energy saving scenario in a cellular network according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 400 and 500 are performed by the system 100 of FIG. 1. In one embodiment, the methods 400 and 500 are performed by the emergency call handling component of FIGS. 1-3.

Referring to FIG. 4, at operation 410, the processing device may determine whether an energy saving function is activated in a base station of the cellular network, wherein the base station comprises a first cell and a second cell. In some implementations, to determine whether an energy saving function is activated in a base station, the processing device may determine whether a first parameter of the base station has a first value. In some implementations, responsive to determining that the first parameter of the base station has the first value, the processing device may determine that the energy saving function is activated in the base station.

At operation 420, responsive to determining that the energy saving function is activated in the base station, the processing device may whether the first cell is scheduled to be turned off at a first time point. In some implementations, to determine whether the first cell is scheduled to be turned off at the first time point, the processing device may determine whether a second parameter of the first cell has a second value, wherein the second value specifies the first time point. In some implementations, responsive to determining that second parameter of the first cell has the second value specifying the first time point, the processing device may determine that the first cell is scheduled to be turned off at the first time point.

At operation 430, responsive to determining that the first cell is scheduled to be turned off at the first time point, the processing device may determine, at the first time point, whether one or more ongoing calls using the first cell comprise an emergency call. In some implementations, to determine, at the first time point, whether one or more ongoing calls using the first cell comprise an emergency call, the processing device may determine one or more third parameters of data transmission in the cell has one or more third values, where the one or more third values indicate that the data transmission includes the emergency call. In some implementations, responsive to determining that one or more third parameters of data transmission in the cell has one or more third values, the processing device may determine, at the first time point, that one or more ongoing calls using the first cell comprise an emergency call.

At operation 440, responsive to determining that the one or more ongoing calls using the first cell comprise the emergency call, the processing device may postpone turning off the first cell. In some implementations, to postpone turning off the first cell, the processing device may change a fourth value of a fourth parameter of the cell, wherein the fourth parameter specifies a time point to turn off the cell. In some implementations, to postpone turning off the first cell, the processing device may change the second value of the second parameter described in operation 420 to a fourth value, wherein the fourth parameter specifies a second time point.

At operation 450, the processing device may determine whether the emergency call is finished, and responsive to determining that the emergency call is finished, turn off the first cell.

Referring to FIG. 5, at operation 510, the processing device may determine whether an energy saving function is activated in a base station of the cellular network, wherein the base station comprises a first cell and a second cell, which may be similar to or same as the operation 410. In some implementations, responsive to determining that the energy saving function is not activated in the base station, the processing device may end the process.

At operation 520, responsive to determining that the energy saving function is activated in the base station, the processing device may whether the first cell is scheduled to be turned off at a first time point, which may be similar to or same as the operation 420. In some implementations, responsive to determining that the first cell is not scheduled to be turned off, the processing device may end the process.

At operation 530, responsive to determining that the first cell is scheduled to be turned off at the first time point, the processing device may determine, at the first time point, whether one or more ongoing calls using the first cell comprise an emergency call, which may be similar to or same as the operation 430. In some implementations, responsive to determining, at the first time point, that one or more ongoing calls using the first cell do not comprise an emergency call, the processing device may handover the one or more ongoing calls from the first cell to the second cell.

At operation 540, responsive to determining that the one or more ongoing calls using the first cell comprise the emergency call, the processing device may postpone turning off the first cell, which may be similar to or same as the operation 440.

At operation 550, the processing device may determine whether the emergency call is finished. In some implementations, responsive to determining that the emergency call is not finished, the processing device may continue postponing turning off the first cell. At operation 560, responsive to determining that the emergency call is finished, the processing device may turn off the first cell.

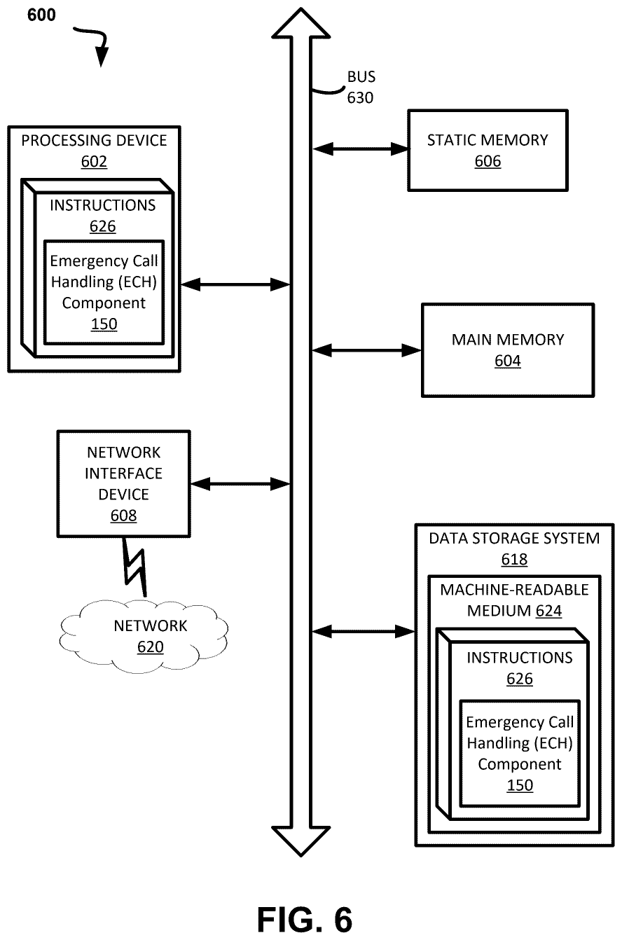

FIG. 6 illustrates an example machine of a computer system 600 within which a set of instructions, for causing the machine to perform any one or more of the methodologies discussed herein, can be executed. In some embodiments, the computer system 600 can be used to perform the operations of a controller (e.g., to execute an operating system to perform operations corresponding to the emergency call handling component 150 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620. The network 620 may correspond to the cellular network 120 of FIG. 1, or the 5G network 220 of FIG. 2.

The data storage system 618 can include a machine-readable storage medium 624 (also known as a computer-readable medium or a non-transitory computer-readable storage medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The processing device 602, the network interface 608, and the network 620 can correspond to the system 100 of FIG. 1, or the system 200 of FIG. 2.

In one embodiment, the instructions 626 include instructions to implement functionality corresponding to the emergency call handling component 150 of FIGS. 1-3. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of emergency call handling in energy saving scenario in a cellular network, the method comprising:
determining whether an energy saving function is activated in a base station of the cellular network, wherein the base station comprises a first cell and a second cell;
responsive to determining that the energy saving function is activated in the base station, determining whether the first cell is scheduled to be turned off at a first time point;
responsive to determining that the first cell is scheduled to be turned off at the first time point, determining, at the first time point, whether one or more ongoing calls using the first cell comprise an emergency call; and
responsive to determining that the one or more ongoing calls using the first cell comprise the emergency call, postpone turning off the first cell.

2. The method of claim 1, further comprising:
determining whether the emergency call is finished; and
responsive to determining that the emergency call is finished, turning off the first cell.

3. The method of claim 1, wherein determining whether the energy saving function is activated in a base station comprises:
determining whether a first parameter of the base station has a first value.

4. The method of claim 1, wherein determining whether the first cell is scheduled to be turned off at the first time point comprises:
determining whether a second parameter of the first cell has a second value, wherein the second value specifies the first time point.

5. The method of claim 1, wherein determining, at the first time point, whether the one or more ongoing calls using the first cell comprise the emergency call comprises:
determining one or more third parameters of data transmission in the cell has one or more third values, where the one or more third values indicate that the data transmission includes the emergency call.

6. The method of claim 1, wherein postponing turning off the first cell comprises:
changing a fourth value of a fourth parameter of the cell, wherein the fourth parameter specifies a time point to turn off the cell.

7. The method of claim 1, wherein determining whether the first cell is scheduled to be turned off at the first time point comprises:
determining whether a second parameter of the first cell has a second value, wherein the second value specifies the first time point, and
wherein postponing turning off the first cell comprises:
changing the second value of the second parameter to a fourth value, wherein the fourth parameter specifies a second time point.

8. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
determining whether an energy saving function is activated in a base station of the cellular network, wherein the base station comprises a first cell and a second cell;
responsive to determining that the energy saving function is activated in the base station, determining whether the first cell is scheduled to be turned off at a first time point;
responsive to determining that the first cell is scheduled to be turned off at the first time point, determining, at the first time point, whether one or more ongoing calls using the first cell comprise an emergency call; and
responsive to determining that the one or more ongoing calls using the first cell comprise the emergency call, postpone turning off the first cell.

9. The computing system of claim 8, wherein the operations further comprise:
determining whether the emergency call is finished; and
responsive to determining that the emergency call is finished, turning off the first cell.

10. The computing system of claim 8, wherein determining whether the energy saving function is activated in a base station comprises:
determining whether a first parameter of the base station has a first value.

11. The computing system of claim 8, wherein determining whether the first cell is scheduled to be turned off at the first time point comprises:
determining whether a second parameter of the first cell has a second value, wherein the second value specifies the first time point.

12. The computing system of claim 8, wherein determining, at the first time point, whether the one or more ongoing calls using the first cell comprise the emergency call comprises:
determining one or more third parameters of data transmission in the cell has one or more third values, where the one or more third values indicate that the data transmission includes the emergency call.

13. The computing system of claim 8, wherein postponing turning off the first cell comprises:
changing a fourth value of a fourth parameter of the cell, wherein the fourth parameter specifies a time point to turn off the cell.

14. The computing system of claim 8, wherein determining whether the first cell is scheduled to be turned off at the first time point comprises:
determining whether a second parameter of the first cell has a second value, wherein the second value specifies the first time point, and
wherein postponing turning off the first cell comprises:
changing the second value of the second parameter to a fourth value, wherein the fourth parameter specifies a second time point.

15. One or more non-transitory, computer-readable storage media having computer-readable instructions thereon which, when executed by one or more processing devices, cause the one or more processing devices to perform operations comprising:
determining whether an energy saving function is activated in a base station of a cellular network, wherein the base station comprises a first cell and a second cell;
responsive to determining that the energy saving function is activated in the base station, determining whether the first cell is scheduled to be turned off at a first time point;
responsive to determining that the first cell is scheduled to be turned off at the first time point, determining, at the first time point, whether one or more ongoing calls using the first cell comprise an emergency call; and
responsive to determining that the one or more ongoing calls using the first cell comprise the emergency call, postpone turning off the first cell.

16. The one or more non-transitory, computer-readable storage media of claim 15, wherein the operations further comprise:
determining whether the emergency call is finished; and
responsive to determining that the emergency call is finished, turning off the first cell.

17. The one or more non-transitory, computer-readable storage media of claim 15, wherein determining whether the energy saving function is activated in a base station comprises:
determining whether a first parameter of the base station has a first value.

18. The one or more non-transitory, computer-readable storage media of claim 15, wherein determining whether the first cell is scheduled to be turned off at the first time point comprises:
determining whether a second parameter of the first cell has a second value, wherein the second value specifies the first time point.

19. The one or more non-transitory, computer-readable storage media of claim 15, wherein determining, at the first time point, whether the one or more ongoing calls using the first cell comprise the emergency call comprises:
determining one or more third parameters of data transmission in the cell has one or more third values, where the one or more third values indicate that the data transmission includes the emergency call.

20. The one or more non-transitory, computer-readable storage media of claim 15, wherein postponing turning off the first cell comprises:
changing a fourth value of a fourth parameter of the cell, wherein the fourth parameter specifies a time point to turn off the cell.
